(19) United States
(12) Patent Application Publication
(10) Pub. No.: US 2023/0410150 A1
(43) Pub. Date: Dec. 21, 2023

(54) IDENTIFYING TARGET LOCATIONS

(71) Applicant: Conopco Inc., d/b/a UNILEVER, Englewood Cliffs, NJ (US)

(72) Inventor: Uday Sharma, Jalandhar, Punjab (IN)

(73) Assignee: Conopco Inc., d/b/a UNILEVER, Englewood Cliffs, NJ (US)

(21) Appl. No.: 18/251,547

(22) PCT Filed: Nov. 11, 2021
(86) PCT No.: PCT/EP2021/081415

§ 371 Date: May 3, 2023

(30) Foreign Application Priority Data
Nov. 20, 2020 (EP) 20208881.1

(51) Int. Cl. G06Q 30/0251

(52) U.S. Cl. CPC G06Q 30/0261

(57) ABSTRACT

The disclosure relates to a method and apparatus, the apparatus comprising: one or more processors; an output device; and computer memory, the computer memory comprising computer program code configured to: receive a dataset regarding a geographical area, the dataset comprising a set of locations, in which each location is associated with an attribute; divide the geographical area into sections; determine, for one or more of the sections, a section-value based on one or more attributes associated with that particular section; identify the one or more target locations based on one or more sections with a section-value meeting a threshold, in which the output device is configured to provide the one or more target locations to a user.

### FIELD OF THE INVENTION

The invention relates to a system and method for identifying target locations, and in particular, although not exclusively, to identifying locations for targeted marketing, information dissemination, or for performing other technical tasks.

### BACKGROUND OF THE INVENTION

Mapping packages for rendering point data associated with locations on maps are well known in the art. Well known online mapping tools allow information associated with a point location to be displayed in a side-bar, for example. However, the present inventor has realised that there is a need in the field for a comprehensive tool to assist with identifying target locations. For example, targets are selected to service geographic areas in a wide range of fields, including irrigation, mining, farming and marketing.

Various aspects in the present disclosure address problems relating to identifying target locations based on data and/or locations associated with a geographical area.

### SUMMARY OF THE INVENTION

According to a first aspect there is provided a method for one or more identifying target locations, comprising:
receiving a dataset regarding a geographical area, the dataset comprising a set of locations, in which each location is associated with an attribute;
dividing the geographical area into sections;
determining, for one or more of the sections, a section-value based on one or more attributes associated with that particular section; and
identifying the one or more target locations based on one or more sections with a section-value meeting a threshold.

The method allows attributes to be associated with sections of a geographic region and target locations to be determined based on section-values meeting a threshold. In this way, the method provides an improved means for identifying target locations for use in a wide range of fields. Various further aspects of the method are discussed below.

The sections may be grid sections. A map of the geographical area may be rendered. A representation of the section-values for one or more of the sections may be rendered on a map. The one or more target locations may be rendered on a map.

The method may further comprise associating one or more of a set of locations with a respective subarea of the geographical region. The subarea may be defined by a plurality of sections. One or each of the sections may include one or more of the set of locations associated with the subarea. In this way, for example, an area that is serviced by a feature provided at the location may be defined within the geographical region.

The one or more section-values may be based on one or more attributes associated with a subarea in which that particular section is located. For example, each of the sections within the subarea may be attributed the same section-values. In that case, the section-value for the subarea may be based on all of the attributes within the subarea.

The method may further comprise assigning an area identifier associated with a communications network to one or more sections. The area identifier may be a zip code or postal code. The grid may not necessarily be matched one-to-one with a zip code area. In some cases, the use of a postal code, or similar, is particularly convenient for managing the delivery of content to target locations identified by the method. In cases where the area identifier is associated with an electronic communications system, the use of such an identifier may allow for automated delivery of content to the target locations.

The method may comprise associating at least the sections having the minimum coverage level with a respective area identifier for marketing to consumers.

The target locations may be locations for performing a technical task. The subareas may be areas in which the locations provide coverage. For example, a technical effect or service may be ascribed to the subarea by a thing at the location.

The set of locations may include locations of retail outlets. The coverage in a subarea associated with a particular outlet may decline as a function of distance from that outlet. The target locations may be locations for distributing consumer marketing material. Attributes may include one of customer shipping location; item return shipping location; number of stores covered; base area stores; population; total number of orders; total value of orders; number of cancelled orders; value of cancelled orders; affluence index.

Each grid section may comprise one or more of a starting latitude, a starting longitude, height and width.

The method may be a computer implemented method or automated method.

According to a second aspect there is provided an apparatus comprising:
one or more processors;
an output device; and
computer memory, the computer memory comprising computer program code configured to:
   receive a dataset regarding a geographical area, the dataset comprising a set of locations, in which each location is associated with an attribute;
divide the geographical area into sections;
determine, for one or more of the sections, a section-value based on one or more attributes associated with that particular section;
   identify the one or more target locations based on one or more grid sections with a section-value meeting a threshold,
      in which the output device is configured to provide the one or more target locations to a user.

### BRIEF DESCRIPTION OF FIGURES

One or more embodiments will now be described by way of example only with reference to the accompanying drawings in which:

FIG. 1 illustrates a block diagram of a method for identifying target locations;

FIG. 2 illustrates a block diagram of another method for identifying target locations;

FIG. 3a illustrates a representation of a geographical region and point locations;

FIG. 3b illustrates the point locations of FIG. 3a and associated areas;

FIG. 4 illustrates a representation of another geographical region with point locations and associated areas;

FIG. 5 illustrates a representation of another geographical region with point locations and associated areas;

FIG. 6 illustrates a representation of a geographical region with point locations and grid sections assigned to zip code areas; and

FIG. 7 illustrates a schematic block diagram of a computer system.

### DETAILED DESCRIPTION OF THE INVENTION

Identifying Target Locations

A first aspect of the invention relates to a method for identifying target locations. Typically, the method is implemented as a computer implemented method. The method comprises receiving a dataset regarding a geographical area. The dataset comprises a set of locations. Each location may be associated with an attribute. Attributes may include an identity for a type of thing present at the location or a value associated with a type of thing present at the location.

The method includes dividing the geographical area into sections. A section-value is determined for each section based on attributes corresponding to locations within that particular section. One or more target locations are identified based on sections with a grid-section-value meeting a threshold. For example, the one or more target locations may be chosen as locations associated with sections that have a particular section-value or section-value within a particular range.

The target locations may be locations for performing a variety of different types of technical task. In this way, the method may assist the user in performing a technical task by identifying locations in which the task should be performed. The output of the method dynamically changes depending on the input data, which itself is a description of a real-world information corresponding to the geographical area. In such examples, the cognitive content of the information presented to the user relates to an internal state prevailing in a technical system and the method enables the user to properly operate this technical system.

For example, the method may be used to identify target locations for drilling for oil. In such examples, the attributes may be oil reservoir volumes associated with oil wells at geographic location values, and a location associated with a respective subarea may be an oil well. Alternatively, the method may be used to identify target locations for planting crops. In such examples, the attributes may be the size of pollinator colonies, such as beehives, associated with geographic locations. Alternatively, the locations may be the site of an irrigation system that services a subarea of the geographical region. The method may be used to identify target locations related to a wide range of technical considerations.

In some examples, the target locations are locations for distributing consumer marketing material. Consumer marketing material may be distributed by technical means, such as by electronic mail or via electronic messaging. In some examples, the method may include assigning an area identifier associated with a communications network to one or more grids. The destinations for electronic messages may be coded based on the assigned area identifiers.

Computer Program and Hardware

According to a further aspect of the disclosure there is provided a data processing unit configured to perform any method described herein as a computer-implementable. The data processing unit may comprise one or more processors and memory, the memory comprising computer program code configured to cause the processor to perform any method described herein. Various components of the system may be implemented using generic means for computing known in the art. For example, one or more input devices may comprise a keyboard or mouse. One or more output devices may comprise a monitor or display, and an audio output device such as a speaker.

According to a further aspect of the disclosure there is provided a computer readable storage medium comprising computer program code configure to cause a processor to perform any computer-implementable method described herein. The computer readable storage medium may be a non-transitory computer readable storage medium.

There may be provided a computer program, which when run on a computer, causes the computer to configure any apparatus, including a circuit, unit, controller, device or system disclosed herein to perform any method disclosed herein. The computer program may be a software implementation. The computer may comprise appropriate hardware, including one or more processors and memory that are configured to perform the method defined by the computer program.

The computer program may be provided on a computer readable medium, which may be a physical computer readable medium such as a disc or a memory device, or may be embodied as a transient signal. Such a transient signal may be a network download, including an internet download. The computer readable medium may be a computer readable storage medium or non-transitory computer readable medium.

The method may be performed by computer software comprising a number of modules. In one example, the software may have a descriptive module and a grid module.

Descriptive Module

The descriptive module provides basic mapping functionality and may be implemented by conventional open source mapping tools that are commonly known in the art. The mapping module is configured to allow basic information to be displayed on a map, such as allowing a pinpoint location in a geographical area to be associated with information.

The descriptive module may allow visualization of a map representing the underlying geographical area and overlaid information represented by a data set of location points associated with attributes. Display settings such as text size, pinpoint size, pinpoint colour and opacity can be set in accordance with an attribute associated with the particular location.

The descriptive module is configured to link points on a base map (e.g. points defined by a latitude and longitude) with other descriptive attributes for the point. For example, a map could include points corresponding to the locations of supermarket outlets, with each location linked to an average review score or an order cancellation rate for that outlet.

Grid Module

The grid module is configured to overlay a grid on the base map, dividing the map into smaller sections and associating each point on the map with one or more grid sections. When used with the descriptive module, each grid cell can take on attributes of the map points contained in the grid cell. Thus, the grid acts as an intermediate layer to transfer properties of the descriptive attributes to subareas of the geographical region.

### EXAMPLES

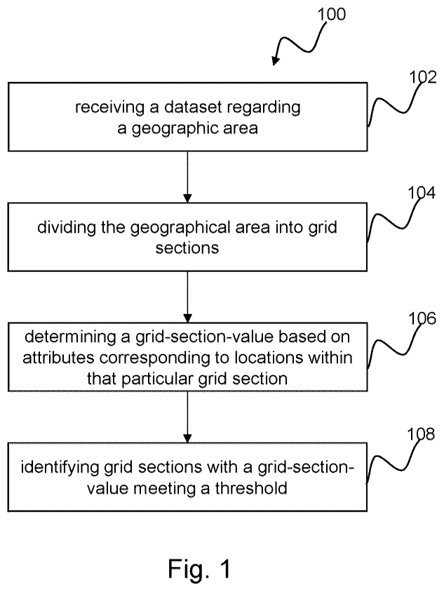

FIG. 1 illustrates a block diagram of a method 100 for identifying target locations. Typically, the method is implemented as a computer implemented method. The method 100 comprises receiving 102 a dataset regarding a geographical area. The dataset comprises a set of locations. Each location may be associated with an attribute. Attributes may include an identity for a type of thing present at the location or a value associated with a type of thing present at the location.

The method includes dividing 104 the geographical area into grid sections. A grid-section-value is determined 106 for each grid section based on attributes corresponding to locations within that particular grid section. One or more target locations are identified 108 based on grid sections with a grid-section-value meeting a threshold.

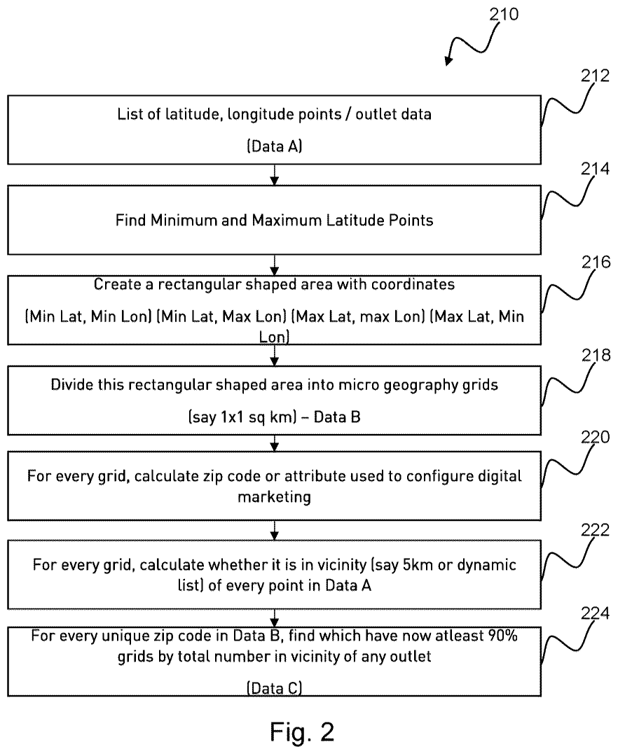

FIGS. 2 to 6 are described below with reference to marketing purposes, although it will be appreciated that the methods described in relation to those embodiments may also be used in other technical contexts.

FIG. 2 illustrates a block diagram of another method for identifying target locations. In this example, the method is used for marketing purposes. ‘Shopper targeting’ relates to a way of improving the targeting of advertisements to regions where the advertisement is most likely to be relevant. Targeted advertising commonly targets consumers on a city-wide basis, for example an advert for a retailer with stores in New Delhi may be targeted at all New Delhi ZIP codes.

However, in the method described with reference to FIG. 2, shopper marketing or digital marketing is targeted at a microgeography level by creating a dynamic pincode/zip code grid system. A microgeography is a geographical area that is smaller than a city or typical zip code area, generally around 1 sq. km. A microgeography may be associated with a single grid section of a wider geographical area.

Shopper marketing may involve sending a dynamic digital communication to shoppers on their respective mobile devices based upon their current locations.

In particular, FIG. 2 illustrates a method comprising—
Receiving 212 a list of longitude and latitude values defining locations of outlets. The outlets maybe retail stores or distribution centres. The data provided by the list of points is referred to as Data A.
In order to define a geographical area, minimum and maximum latitudes from within Data A may be identified 214.
The geographical area may be defined 216 as a rectangular shaped area with minimum and maximum coordinates.
This geographical area (also known as a lattice) may be divided into smaller grid sections that are customizable by both size and number. Each grid section defines a micro geography. For example, each grid section may be a 1 by 1 kilometre square. In some examples, a grid section may be defined as having a starting latitude, starting longitude, height and width. In this way, each grid section in the lattice may be uniquely defined by four data points. The grid section data may be referred to as Data B.
In addition, a number of additional parameters, or attributes, may be calculated for each grid section based on their overall position in the lattice and external data. Parameter include how many shoppers or outlets fall within a particular grid section.
For every grid section, a zip code or other identifier used to configure digital marketing destinations may be calculated 220. In this way, the lattice of grid sections may provide an approximation of zip code boundaries.
In some examples, for every grid section, it can be calculated 222 whether or not the grid section is in a vicinity of a data point in Data A.
In this way, grid sections and associated zip codes that are serviced by a particular outlet, or capable of servicing a particular consumer, may be identified.
The method may therefore be used to select zip codes or grid sections having a particular threshold coverage level (such as 80% or 90%). A marketing campaign may then be limited to such zip codes or grid sections. The grid sections in Data B that are selected 224 provide an output (Data C) indicative of target locations for marketing purposes. Such a method may be more efficient than traditional methods in which a marketing campaign is targeted at a particular city or static list of zip codes.

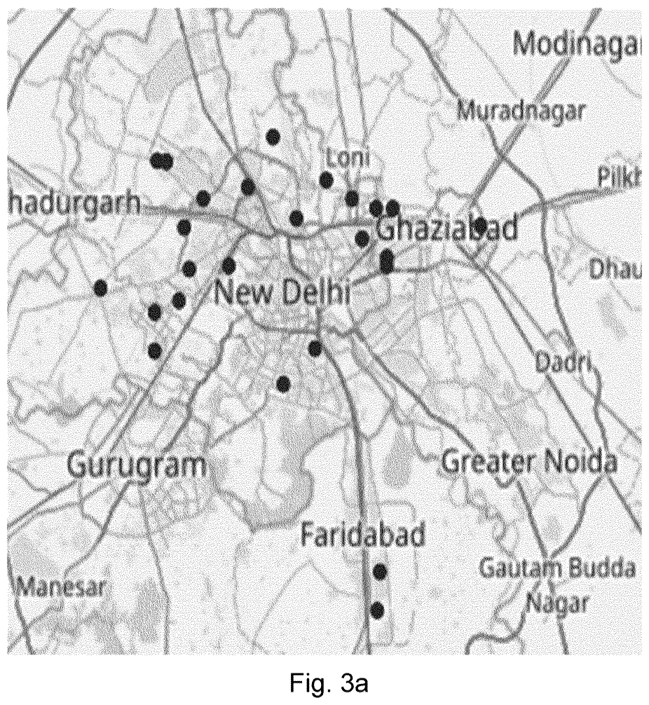

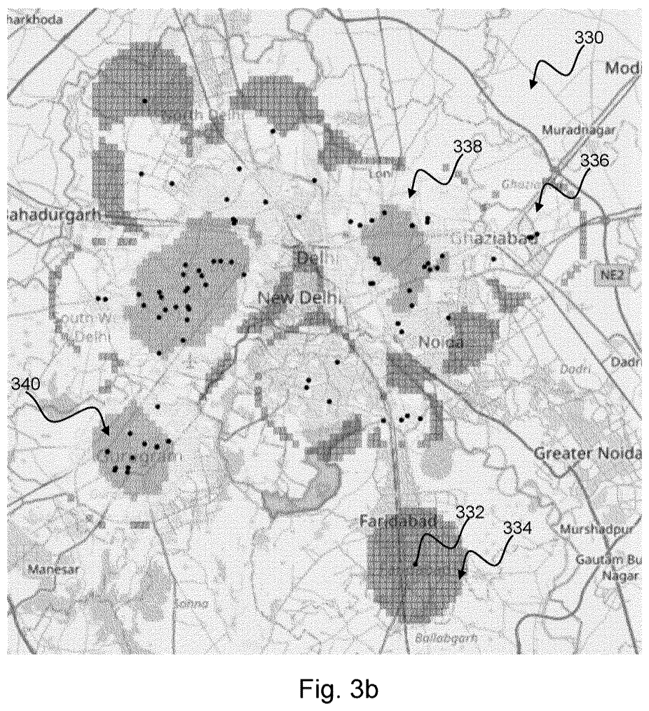

FIG. 3a illustrates an example of a visualization produced by a descriptive module in accordance with an aspect of the disclosure. The visualization comprises a background map associated with a geographical area and a number of data points overlaid on the background map. In this example, the data points are each associated with the location of a retail outlet. In this example, an attribute associated with each location is that it is a retail outlet.

However, a base map with map points and associated descriptive attributes does not readily show how different location points interact or are associated with each other, e.g. the density or distribution of various attributes. This can be achieved by combining the descriptive module with a grid module.

FIG. 3b illustrates such a visualization based on the data shown in FIG. 3a. The attributes can be shown visually for the base map, e.g. as a heatmap with each grid cell being assigned a colour representing an attribute value. The formation of grid cells allows for a different type of analytics (region-by-region rather than point-by-point analysis), giving concise insights about different regions of the base map.

FIG. 3b illustrates a base map layer 330 on which a number of point locations 332 are superimposed. In this example, the point locations 332 correspond to the locations of retail stores within the geographic region. A coverage area 334 is associated with each of the point locations 332. In this example, the coverage area 334 is defined as a circular area with a corresponding point location 332 at its centre. The radius of the coverage area 334 is proportional to an attribute associated with the point location 332, in this example. In this example, the attribute relates to a size of the retail store. The size attribute may be defined qualitatively, in terms of a metropolitan store, superstore or megastore, for example. Alternatively, the size of the store may be defined in terms of its floor area.

In this example, the coverage attributed to a particular point location is treated as being uniform across its subarea. Alternatively, the coverage in a subarea associated with a particular location may decline as a function of distance from that location.

Some regions within the geographical area described by the base map 330 are more densely populated than others. Typically, more stores are provided in the most densely populated areas, although other criteria may be used to decide the location of retail stores.

In some portions of the geographical area, multiple coverage areas 334 associated with point locations 332 overlap. The overlapping coverage area from a limited number of point locations 332 results in a first overlapping coverage area 336, in which the coverage is considered to be greater than in a coverage area 334 provided by a single point location 332. An overlap in coverage areas from a greater number of point locations results in a second overlapping coverage area 338, in which the coverage is considered to be greater than in a first overlapping coverage area 336. An overlapping coverage area defined by a greater still number of point locations 332 is defined as a third overlapping coverage area 340, in which the coverage is considered to be greater than that in the second overlapping coverage area 338.

In the example show in FIG. 3b, different shading or colour coding can be used to render the different coverage areas 334 and overlapping coverage areas 336, 338, 340.

In this example, a gridded map showing the coverage for a particular retailer (e.g. how many of the retailer's stores are within 5 km of the grid cell) can be used to provide more precisely targeted advertisements for that retailer. Firstly, it can be determined which grid cells correspond to each ZIP code. Then, the map can be used to determine which ZIP codes contain a sufficient proportion of grid cells which are within a threshold distance from one of the retailer's outlets (e.g. over 90% of grid cells within 5 km of an outlet).

In some examples, a user can plot square/rectangular static or dynamic grid (fixed no of cells or fixed size) on a base map. Each cell of the grid, or section, may have—
1. Start Lat/Long, Height/Width: enabling understanding of which area of base map grid is referring to
2. Section-value: calculated based on information from display/point layer above

Thus, the grid in summary marries base maps image with point/display information. These cells can then be filtered or compared or used with optimization algorithms to provide diagnostic and prescriptive insights. For example, system methods may be used to determine—
which are pincodes where we are covering at least x % of the shoppers (x at present=90);
which pincodes are covered only by single store;
which pincodes have too many stores covering it;
if a store is added/removed, which pincodes have a change in coverage;
the minimum number of stores resulting in maximum pincodes being covered.

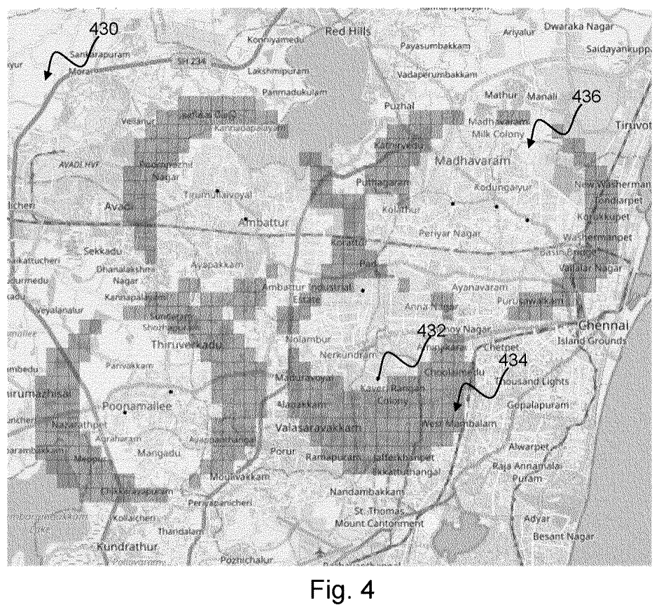

FIG. 4 illustrates another base map layer 430 with a number of point locations 432 overlaid on the base map layer 430. As described previously with reference to FIG. 3b, each point location 432 is associated with a coverage area 434. Regions in which multiple coverage areas overlap are identified as first overlapping coverage areas 436. In this case, the first overlapping coverage areas 436 are considered to be medium coverage density areas in which between two and four coverage areas 434 overlap.

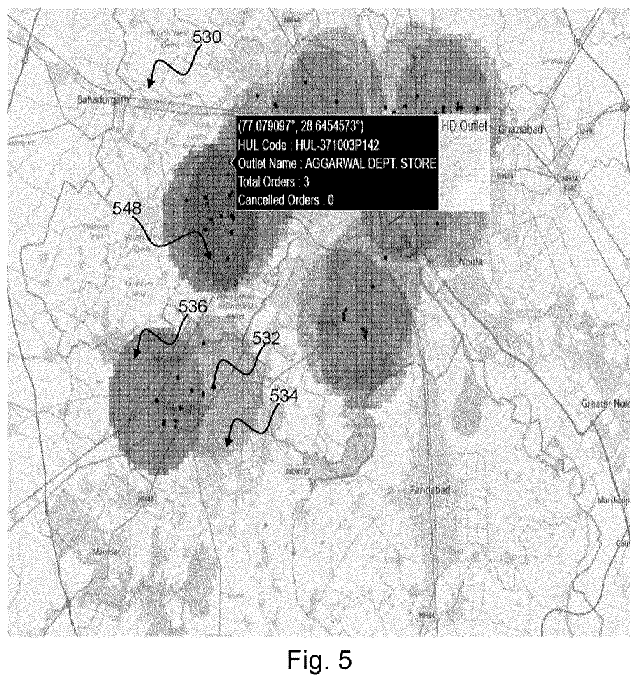

FIG. 5 illustrates another example of a base map layer 530 overlaid with data generated in accordance with the present methods.

In this example, each point location 532 represents a retail store as described previously with reference to FIG. 4, and an area 534 is associated with each retail store 532. However, in this example, an attribute associated with the retail store relates to the number of order cancellations received by that store. The area 534 associated with the point location 532 takes on the value associated with the attribute.

Areas 534 associated with different point locations 532 can overlap to result in the overlapping region taking section-values based on a combination of the overlapping areas 534. In this example, the rendered view of the data is coded to illustrate areas in which the number of returns is low (for example fewer than two, as in area 534), low to medium (for example 2 or more and fewer than five, as in area 536) and moderate (for example between five and ten, as in area 548).

An attribute may relate to a type of thing present at the location or a value associated with a type of thing present at the location. In the illustrated example, the attribute associated with the area is taken from the value associated with the point location. In alternative examples, that need not be the case. For example, the extent of a subarea could be defined with respect to the point location but the value ascribed to the area could be based on other data associated with that area. As a specific example, an area could be defined with respect to a retail store and the value ascribed to that area could be based on the number of consumers that are resident within that area.

Other examples of attributes or types of section-values include: customer shipping location; item return shipping location; number of stores covered; base area stores; population; total number of orders; total value of orders; number of cancelled orders; value of cancelled orders; affluence index.

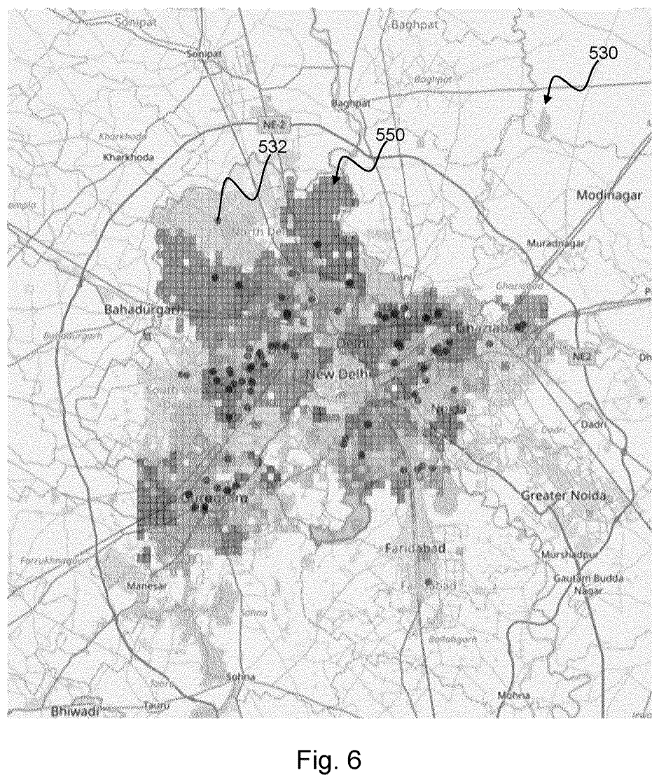

FIG. 6 illustrates another base map layer which includes the geographic region illustrated previously with respect to FIG. 3b. In this example, point locations 532 are illustrated along with representations 550 of pin code, or post code, areas 550. In this way, it would be appreciated that each of the first, second or third overlapping coverage layers, as well as the coverage layers, described previously with reference to FIG. 3b may be associated with a particular pin code area.

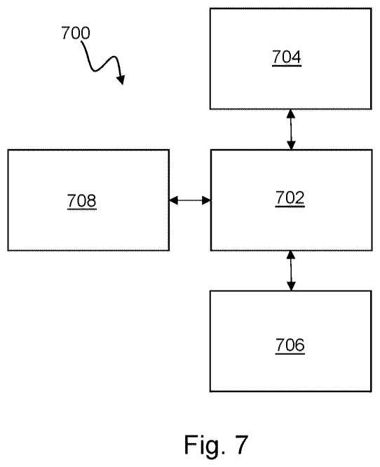

FIG. 7 illustrates a schematic block diagram of a computer system 700 which may be used to implement the methods described previously. The system 700 comprises one or more processors 702 in communication with memory 704. The memory 704 is an example of a computer readable storage medium. The one or more processors 702 are also in communication with one or more input devices 706 and one or more output devices 708. The various components of the system 700 may be implemented using generic means for computing known in the art. For example, the input devices 706 may comprise a keyboard or mouse and the output devices 708 may comprise a monitor or display, and an audio output device such as a speaker.

1. An apparatus comprising:
one or more processors;
an output device; and
computer memory, the computer memory comprising computer program code configured to:
receive a dataset regarding a geographical area, the dataset comprising a set of locations, wherein each location is associated with an attribute;
divide the geographical area into sections;
determine, for one or more of the sections, a section-value based on one or more attributes associated with that particular section;
identify the one or more target locations based on one or more sections with a section-value meeting a threshold,
wherein the output device is configured to provide the one or more target locations to a user.

2. An apparatus according to claim 1, wherein the apparatus is configured to associate each of the one or more of the set of locations with a respective subarea of the geographical region.

3. An apparatus according to claim 2, wherein the subarea is defined by a plurality of sections, wherein one of the sections includes the one or more of the set of locations associated with the subarea.

4. An apparatus according to claim 1, wherein the one or more section-values are based on one or more attributes associated with a subarea wherein that particular section is located.

5. An apparatus according to claim 1, wherein the apparatus is configured to assign an area identifier associated with a communications network to one or more sections.

6. An apparatus according to claim 5, wherein the area identifier is a zip code or postal code.

7. An apparatus according to claim 1, wherein the apparatus is configured to associate at least the sections having the minimum coverage level with a respective area identifier for marketing to consumers.

8. An apparatus according to claim 1, wherein the target locations are locations for performing a technical task.

9. An apparatus according to claim 2, wherein the subareas are areas wherein the locations provide coverage.

10. An apparatus according to claim 1, wherein the set of locations includes locations of retail outlets, and wherein the coverage in a subarea associated with a particular outlet declines as a function of distance from that outlet.

11. An apparatus according to claim 1, wherein the target locations are locations for distributing consumer marketing material.

12. An apparatus according to claim 1, wherein the attributes include one of customer shipping location; item return shipping location; number of stores covered; base area stores; population; total number of orders; total value of orders; number of cancelled orders; value of cancelled orders; affluence index.

13. An apparatus according to claim 1, wherein each of the section comprises at least a starting latitude, a starting longitude, height and width.

14. A method for identifying one or more target locations, comprising:
receiving a dataset regarding a geographical area, the dataset comprising a set of locations, wherein each location is associated with an attribute;
dividing the geographical area into sections;
determining, for one or more of the sections, a section-value based on one or more attributes associated with that particular section; and
identifying the one or more target locations based on one or more sections with a section-value meeting a threshold.

15. A computer readable storage medium comprising computer program code configure to cause a processor to perform the method according to claim 14.
